(19) United States
(12) Patent Application Publication
(10) Pub. No.: US 2008/0288137 A1
(43) Pub. Date: Nov. 20, 2008

(54) Vehicle-Mounted Load Drive Control System

(75) Inventor: Yoshiaki Hatta, Yokkaichi-Shi (JP)

Correspondence Address: OLIFF & BERRIDGE, PLC, P.O. BOX 320850, ALEXANDRIA, VA, 22320-4850, US

(73) Assignees: AUTONETWORKS TECHNOLOGIES, LTD., YOKKAICHI-SHI (JP); SUMITOMO WIRING SYSTEMS, LTD., YOKKAICHI-SHI (JP); SUMITOMO ELECTRIC INDUSTRIES, LTD., OSAKA-SHI (JP)

(21) Appl. No.: 11/990,919

(22) PCT Filed: Sep. 15, 2006
(86) PCT No.: PCT/JP2006/318402

§ 371 Date: Feb. 25, 2008

(30) Foreign Application Priority Data
Sep. 16, 2005 (JP) 2005-269898

(51) Int. Cl. G06F 19/00

(52) U.S. Cl. 701/36

(57) ABSTRACT

It is an object of the invention to provide a vehicle-mounted load drive control system that allows synchronous drive of electrical loads located at dispersed sites while achieving great efficiency in mounting in a limited space. Bus connections between an electronic control unit (13A) connected to a load drive switch (12A) and electronic control units (13B to 13D) are established via a multiplex communication line (14) to which CAN is applicable. The electronic control unit (13A) stores a drive command signal from the load drive switch (12A) in a storage (13Aa), and generates and transmits a data frame to the electronic control units (13B to 13D). The electronic control units (13B to 13D) drive electrical loads (15) upon receipt of a transmission signal, and the electronic control unit (13A) drives electrical loads (15) at the completion of transmission of the transmission signal. At the detection of a communication error, the prescribed contents of fail-safe processing is carried out.

### TECHNICAL FIELD

The present invention relates to techniques relating to a vehicle-mounted load drive control system for, in drive controlling electrical loads in a vehicle, transmitting via a multiplex communication line a synchronous-drive command signal for electrical loads responsive to the state of operation of a control switch by a passenger.

### BACKGROUND ART

Vehicles include electrical loads to be synchronously driven by the supply of power supply voltage output from a power supply device (battery), and include a vehicle-mounted load drive control system for controlling such synchronous drive of the electrical loads.

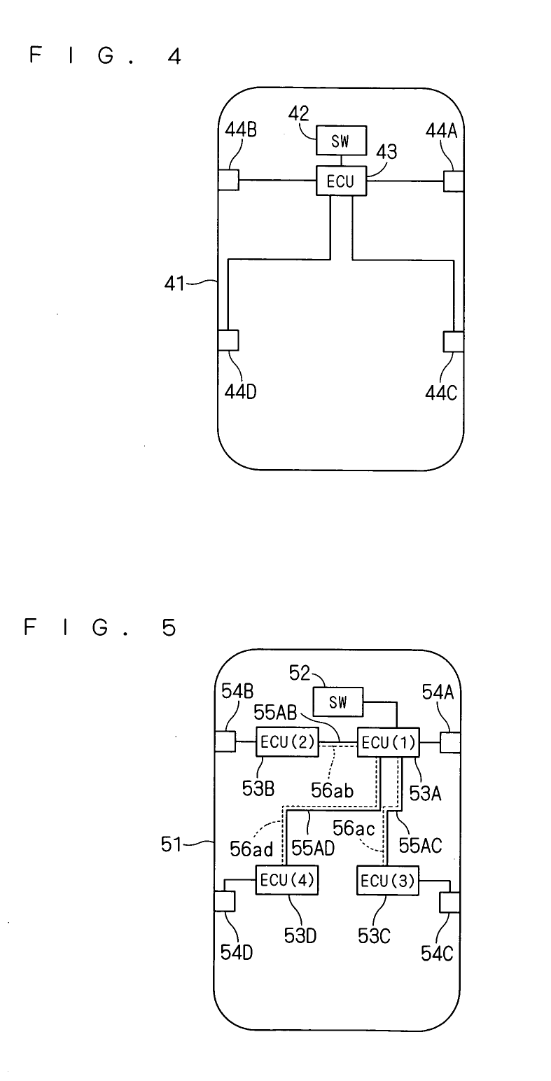

The vehicle-mounted load drive control system is, for example as shown in FIG. 4, a system for controlling synchronous drive of electrical loads (such as lamps) 44A to 44D which are in direct connection to an ECU 43 by actuation of a load drive switch 42 mounted in a vehicle 41 (first technique).

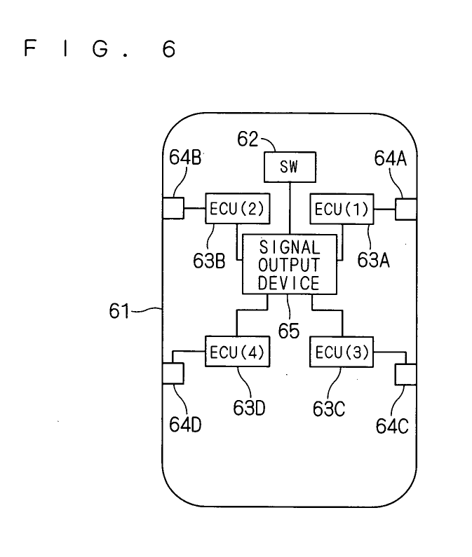

Alternatively, it may, for example as shown in FIG. 5, be another system for controlling an ECU(2) 53B, an ECU(3) 53C, and an ECU(4) 53D which are in direct connection to an ECU(1) 53A by actuation of a load drive switch 52 mounted in a vehicle 51, thereby to control synchronous drive of electrical loads 54A to 54D which are in direct connection to the ECU(1)-(4) 53A to 53D, respectively (second technique).

Alternatively, it may, for example as shown in FIG. 6, be still another system in which a signal output device 65 outputs a synchronizing signal to ECU(1)-(4) 63A to 63D by actuation of a load drive switch 62 mounted in a vehicle 61, so that the ECU(1)-(4) 63A to 63D control synchronous drive of electrical loads 63A to 64D (third technique).

### DISCLOSURE OF INVENTION

{Issues in First Technique}

However, in the aforementioned first technique, it is necessary to cable an appropriate number of harnesses depending on the number of the electrical loads 44A to 44D mounted in the vehicle 41, which raises various issues such as a necessity to improve efficiency in cabling, weight increase, and cost increase.

{Issues in Second Technique}

Although the aforementioned second technique achieves improvement in the efficiency of cabling and weight reduction, out of the issues of the aforementioned first technique, by decentralized control of the plurality of electrical loads 54A to 54D mounted in the vehicle 51 using the plurality of ECU(1)-(4) 53A to 53D, it is still necessary to cable synchronizing signal lines 56ab, 56ac, and 56ad between the ECU(1)-(4) 53A to 53D for synchronous drive of the electrical loads 54A to 54D, separately from communication lines 55AB, 55AC, and 55AD for communication between the ECU(1)-(4) 53A to 53D. Accordingly, the second technique is not satisfying.

{Issues in Third Technique}

In the aforementioned third technique, it is necessary to separately provide the signal output device 65 for synchronous drive of the electrical loads 64A to 64D. Accordingly, in view of the issues such as a necessity to improve efficiency in mounting and cabling, and weight increase especially in a limited space such as in the vehicle 61, the first and second techniques are superior.

Hence, the object of the invention is to provide a vehicle-mounted load drive control system that can control synchronous drive of electrical loads while achieving great efficiency in mounting, weight reduction, cost reduction, and the like even in a limited space such as in a vehicle.

To solve the aforementioned issues, the invention is directed to a vehicle-mounted load drive control system for synchronous drive of a plurality of electrical loads responsive to control and input by an operator. The vehicle-mounted load drive control system includes a load drive switch for control and input by an operator; a first electronic control unit connected to the load drive switch; a second electronic control unit connected to the first electronic control unit via a communication line; a first electrical load connected to the first electronic control unit; and a second electrical load connected to the second electronic control unit. The first electronic control unit, based on a drive command input from the load drive switch, drives the first electrical load at a completion of transmission of the drive command to the second electronic control unit, and the second electronic control unit drives the second electrical load upon receipt of and based on a drive command transmitted from the first electronic control unit.

In the vehicle-mounted load drive control system of the invention, since it is unnecessary to provide a signal output device for use as a load driver unlike in the conventional techniques, efficient mounting is possible even in a limited space such as in a vehicle. Further, since the electrical load directly connected to the first electronic control unit is driven at the completion of transmission of the drive command from the first electronic control unit, and the electrical load directly connected to the second electronic control unit is driven upon receipt of the drive command by the second electronic control unit, it becomes possible to almost simultaneously drive the plurality of electrical loads.

In this case, the first electronic control unit may further include communication error detecting means for detecting the occurrence of an error in communication processing via the communication line, and fail-safe processing execution means for carrying out prescribed fail-safe processing when the communication error detecting means detects a communication error.

The provision of the communication error detecting means for detection of the occurrence of an error in communication processing between the first electronic control unit and the second electronic control unit, and the execution of the prescribed fail-safe processing at the detection of a communication error enable safe drive control of the vehicle-mounted loads.

Alternatively, CAN may be used a communication protocol between the first electronic control unit and the second electronic control unit.

The application of CAN as a communication protocol between the first electronic control unit and the second electronic control unit allows the establishment of bus connections between the electronic control units, and thereby eliminates the need of conductive cables.

These and other objects, features, aspects and advantages of the invention will become more apparent from the following detailed description of the invention when taken in conjunction with the accompanying drawings.

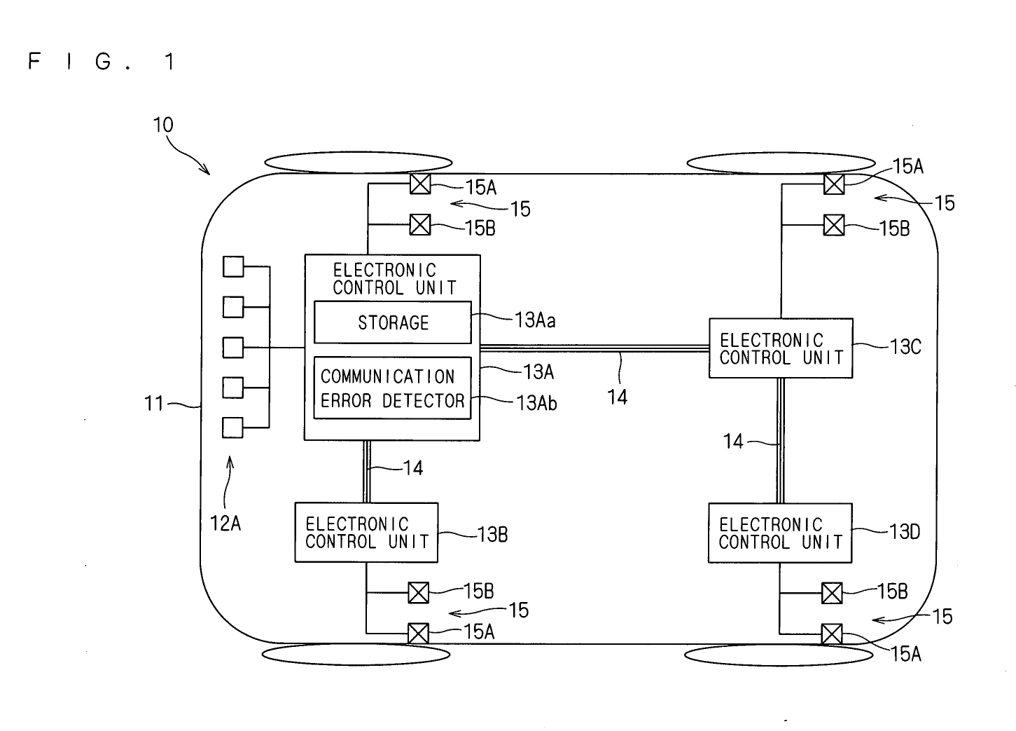

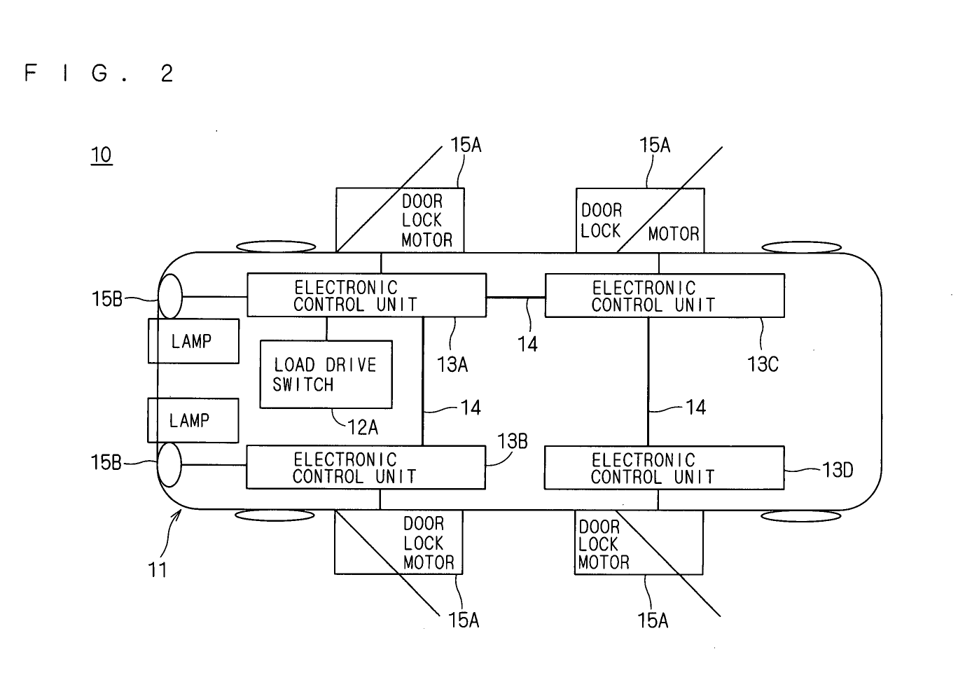

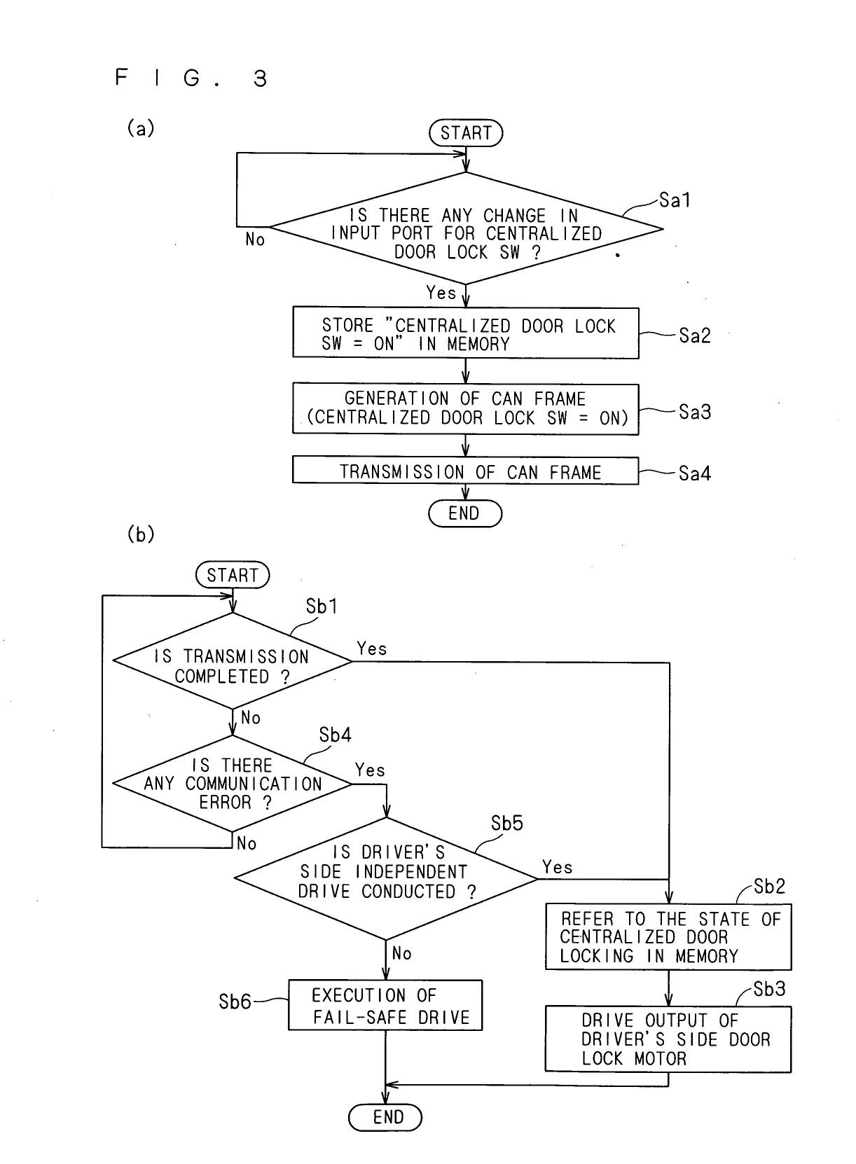

### BRIEF DESCRIPTION OF DRAWINGS

[FIG. 1] is a block diagram of a vehicle-mounted load drive control system according to an embodiment of the invention;

[FIG. 2] is another block diagram of the vehicle-mounted load drive control system according to the embodiment of the invention;

[FIG. 3] FIG. 3(a) is a flowchart showing the operation of a first electronic control unit in the vehicle-mounted load drive control system according to the embodiment of the invention; and FIG. 3(b) is a flowchart showing the operation of the vehicle-mounted control drive system according to the embodiment of the invention;

[FIG. 4] shows a vehicle-mounted load drive control system according to a first technique;

[FIG. 5] shows a vehicle-mounted load drive control system according to a second technique; and

[FIG. 6] shows a vehicle-mounted load drive control system according to a third technique.

### BEST MODE FOR CARRYING OUT THE INVENTION

<Configuration>

FIG. 1 is a block diagram showing a vehicle-mounted load drive control system according to an embodiment of the invention. A vehicle-mounted load drive control system 10, for example, controls synchronous drive of electrical loads 15 such as door lock motors 15A mounted in the vicinity of the doors of a vehicle 11 and lamps 15B mounted on the four corners of the vehicle 11, and more specifically, it installs load drive switches 12A around the driver's seat of the vehicle 11 and exercises decentralized control using electronic control units 13A to 13D installed in the vicinity of the electrical loads 15 such as the door lock motors 15A and the lamps 15B. Communication between the electronic control units 13A to 13D is established in multiplex communications such as CAN (Controller Area Network). The following description of the embodiment of the invention is given for the case where CAN is used as a protocol in multiplex communications.

Specifically, the vehicle-mounted load drive control system 10, for example as shown in FIG. 2, includes a load drive switch 12A outputting a drive command signal responsive to control and input by a passenger of the vehicle 11, a first electronic control unit 13A connected to the load drive switch 12A, a plurality of second electronic control units 13B to 13D connected to the first electronic control unit 13A via a multiplex communication line 14, and the electrical loads 15A such as the door lock motors 15A and the lamps 15B which are connected to the electronic control units 13A to 13D.

The load drive switch 12A includes, for example around the driver's seat of the vehicle 11, an appropriate plurality of load drive switches 12A depending on the types of the electrical loads 15 such as the door lock motors 15A and the lamps 15B. With each of the load drive switches 12A tuned on by a passenger, a drive command signal (drive command) for synchronously driving the electrical loads 15 is transmitted to the electronic control unit 13A.

The electronic control units 13A to 13D are, for example, respectively installed around the driver's seat, the front passenger seat, the rear seat on the right side, and the rear seat on the left side of the vehicle 11 so as to control the electrical loads 15 installed in the vicinity of the electronic control units 13A to 13D.

The electronic control unit 13A includes storage means 13Aa and communication error detecting means 13Ab, and it stores drive-command-signal information transmitted from the load drive switches 12A for synchronous drive in the storage means 13Aa, and generates a data frame (a drive command as a transmission signal) responsive to the drive command signal. The data frame generated is transmitted to the electronic control units 13B to 13D via the multiplex communication line 14. The other electronic control units 13B to 13D also have the same configuration, and they may be connected to load drive switches (not shown) installed in their vicinities.

The application of CAN as a communication system via the multiplex communication line 14 automatically provides the communication error detecting means 13Ab because, for example when communication from the electronic control unit 13A to the electronic control units 13B to 13D is incomplete due to an error, the electronic control units 13B to 13D generate and transmit an error frame to the electronic control unit 13A.

The electrical loads 15A such as the door lock motors 15A and the lamps 15B for each seat are in direct connection to their nearby electronic control units 13A to 13D.

The electronic control unit 13A, when confirming safe receipt of its transmitted data frame by the electronic control units 13B to 13D by receipt completion notifications from the electronic control units 13B to 13D, drives the electrical loads 15 such as the door lock motor 15A and the lamp 15B which are directly connected to the electronic control unit 13A, based on the drive command signal stored in the storage means 13Aa.

The electronic control units 13B to 13D, upon receipt of the data frame transmitted via the multiplex communication line 14, drive the electrical loads 15 such as the door lock motors 15A and the lamps 15B which are directly connected to the electronic control units 13B to 13D, based on a drive command included in the data frame.

This permits almost simultaneous synchronous drive of the electrical loads 15 located at dispersed sites.

When the communication error detecting means 13Ab detects a communication error after generation of an error frame during communication processing on the transmitted data frame, the electronic control unit 13A either independently drives only the door lock motor 15A on the driver's seat side or carries out fail-safe processing based on the prescribed contents of fail-safe processing stored in the storage means 13Aa.

The prescribed contents of fail-safe processing herein refers to, for example when a communication error is detected in any one of the plurality of electronic control units 13B to 13D at the time of control of locking or unlocking by the door lock motors 15A, driving only the door lock motor 15A directly connected to the electronic control unit 13A based on the drive-command-signal information stored in the storage means 13Aa for locking or unlocking, or using the door lock motors 15A directly connected to the others of the electronic control units 13B to 13D and to the electronic control unit 13A for locking or unlocking.

<Operation>

The operation of the vehicle-mounted load drive control system 10 with the aforementioned configuration, for example in the case of controlling locking or unlocking by the door lock motors 15A, is described with reference to the flowchart of FIG. 3.

First, as shown in FIG. 2, with the load drive switch 12A, which is for example a centralized door lock switch, turned on by the driver's operation, a drive command signal is transmitted to the electronic control unit 13A (step Sa1 in FIG. 3(a)).

The electronic control unit 13A stores the drive command signal transmitted from the load drive switch 12A in the storage means 13Aa (step Sa2). In other words, “centralized door lock SW=ON” is stored in memory. Simultaneously, a data frame responsive to the drive command signal is generated (step Sa3) and transmitted via the multiplex communication line 14 to the electronic control units 13B to 13D (step Sa4).

Then, the electronic control unit 13A confirms whether or not the data frame transmitted has been properly transmitted to the sides of the electronic control units 13B to 13D (step Sb1), and when confirming the completion of the transmission, refers to the drive command signal stored in the storage means 13Aa (step Sb2) and drives the door lock motor 15A directly connected to the electronic control unit 13A for locking or unlocking (step Sb3). On the other hand, the electronic control units 13B to 13D drive the door lock motors 15A directly connected thereto in response to the received data frame for locking or unlocking.

When communication between the electronic control unit 13A and the electronic control units 13B to 13D is incomplete after generation of an error frame (step Sb4), the electronic control unit 13A selects whether or not to independently drive the door lock motor 15A (step Sb5). When independent drive is selected, the drive command signal stored in the storage means 13Aa is referred to (step Sb2) and the door lock motor 15A directly connected to the electronic control unit 13A is driven for locking or unlocking (step Sb3).

When the electronic control unit 13A does not select independent drive, fail-safe processing is carried out based on the prescribed contents of fail-safe processing stored in the storage means 13Aa (step Sb6).

As described, since it is unnecessary to provide a signal output device (see FIG. 6) for use as a load driver unlike in the conventional techniques, efficient mounting is possible even in a limited space such as in the vehicle 11. Further, since the electrical load 15 directly connected to the electronic control unit 13A is driven at the completion of transmission of a transmission signal (drive command) from the electronic control unit 13A, and the electrical loads 15 connected to the electronic control units 13B to 13D are driven upon receipt of the transmission signal, it becomes possible to almost simultaneously drive the plurality of electrical loads 15 located at dispersed sites. Besides, the number of interconnection lines as a while is reduced, which achieves weight reduction and cost reduction.

The provision of the communication error detecting means 13Ab for detection of the occurrence of an error in communication processing between the electronic control unit 13A and the electronic control units 13B to 13D, and the execution of the prescribed fail-safe processing at the detection of a communication error enable safe drive control of the vehicle-mounted loads.

The application of CAN as a communication protocol between the electronic control unit 13A and the electronic control units 13B to 13D allows the establishment of bus connections between the electronic control units 13A to 13D, and thereby eliminates the need of conductive cables.

While the invention has been shown and described in detail, the foregoing description is in all aspects illustrative and not restrictive. It is therefore understood that numerous modifications and variations can be devised without departing from the scope of the invention.

1. A vehicle-mounted load drive control system for synchronous drive of a plurality of electrical loads responsive to control and input by an operator, comprising:
a load drive switch for control and input by an operator;
a first electronic control unit connected to said load drive switch;
a second electronic control unit connected to said first electronic control unit via a communication line;
a first electrical load connected to said first electronic control unit; and
a second electrical load connected to said second electronic control unit,
said first electronic control unit, based on a drive command input from said load drive switch, driving said first electrical load at a completion of transmission of said drive command to said second electronic control unit,
said second electronic control unit driving said second electrical load upon receipt of and based on a drive command transmitted from said first electronic control unit.

2. The vehicle-mounted load drive control system according to claim 1, wherein
said first electronic control unit further includes:
a communication error detector for detecting the occurrence of an error in communication processing via said communication line; and
a fail-safe processor for carrying out prescribed fail-safe processing when said communication error detector detects a communication error.

3. The vehicle-mounted load drive control system according to claim 1, wherein
CAN is used a communication protocol between said first electronic control unit and said second electronic control unit.

4. The vehicle-mounted load drive control system according to claim 2, wherein
CAN is used a communication protocol between said first electronic control unit and said second electronic control unit.
